(19) United States
(12) Patent Application Publication
(10) Pub. No.: US 2016/0294619 A1
(43) Pub. Date: Oct. 6, 2016

(54) Configurable Network Communication Processing System

(71) Applicants: Axel Schroeder, Dresden (DE); Martin Knechtel, Dresden (DE)

(72) Inventors: Axel Schroeder, Dresden (DE); Martin Knechtel, Dresden (DE)

(21) Appl. No.: 14/675,472

(22) Filed: Mar. 31, 2015

(51) Int. Cl. H04L 12/24; H04L 12/58; H04L 29/08

(52) U.S. Cl. CPC H04L 41/0816; H04L 67/306; H04L 51/32; H04L 51/14

(57) ABSTRACT

A configurable network communication processing system provides a network-based service to one or more users of other network communication systems (e.g., social networks). Authentication information for the users of the social networks and rules informing the configurable network communication processing system how to forward information to the social networks are accessed by the configurable network communication processing system. The users then are enabled to submit posts via the configurable network communication processing system. When the configurable network communication processing system receives a post from a user, the rules for the user's account are applied, and the post is forwarded to one or more of the social networks according to the rules.

### BACKGROUND

Multiple services (e.g., social networks) store user account data for multiple users. Each service has a server that receives communications from users and provides information to users regarding the communications received from other users. Each user has one or more computing devices used to send and receive data to the servers of the services.

A user of multiple services has relationships with other users (e.g., friends) on each service. To ensure that a communication (e.g., post) is shared with all associated users requires the user to submit the communication to each service. For example, a user may access a first user interface (UI) for a first social network on a client device, provide credentials for the first social network in the UI, type in a message, and submit the message to the first social network. Then, the user repeats each of these steps for a second (third, etc.) social network.

Particular social networks target different user groups and provide different feature sets. For example, some focus on specific topics (e.g., lifestyle or sport) while others focus on specific media types (e.g., text, pictures, and videos).

### BRIEF DESCRIPTION OF THE DRAWINGS

Some embodiments are illustrated by way of example and not limitation in the figures of the accompanying drawings.

FIG. 1 is a network diagram illustrating a network environment suitable for implementing a configurable network communication processing system, according to some example embodiments.

FIG. 2 is a block diagram of a server machine, according to some example embodiments, suitable for implementing a configurable network communication processing system.

FIG. 3 is a block diagram of a client machine, according to some example embodiments, suitable for interacting with a configurable network communication processing system.

FIG. 4 is a block diagram illustrating a user interface suitable for interacting with a configurable network communication processing system, according to some example embodiments.

FIG. 5 is a block diagram illustrating a user interface suitable for interacting with a configurable network communication processing system, according to some example embodiments.

FIG. 6 is a block diagram illustrating a user interface suitable for interacting with a configurable network communication processing system, according to some example embodiments.

FIG. 7 is a flowchart illustrating operations, according to some example embodiments, of a configurable network communication processing system.

FIG. 8 is a flowchart illustrating operations, according to some example embodiments, of a configurable network communication processing system.

FIG. 9 is a database schema, according to some example embodiments, for use in a configurable network communication processing system.

FIG. 10 is a block diagram illustrating components of a machine, according to some example embodiments.

### DETAILED DESCRIPTION

Example methods and systems are directed to providing a configurable network communication processing system. In some example embodiments, the configurable network communication processing system is a social hub. A social hub is a computing device capable of communicating with other computing devices (e.g., over a network) and of performing one or more of the methodologies described herein. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A social hub acts as a central component distributing contents from a user to a variety of social networks. In some example embodiments, this frees a user from maintaining every single social network individually. A social hub provides a network-based service to one or more users of social networks. Each user provides the social hub with authentication information for each social network used by the user. Each user further provides one or more rules informing the social hub how to forward information to the social networks. The users then are enabled to submit posts via the social hub. For example, a third-party developer can add a button to an app, which, when activated by the user, sends information related to the app to the social hub (e.g., using a representational state transfer (REST) protocol); or any suitable combination thereof.

When the social hub receives a post from a user, the rules for the user's account are applied, and the post is forwarded to one or more of the social networks according to the rules. For example, a user may have rules providing that images are posted to tumblr and Facebook, short text posts posted to twitter and Facebook, and long text posts posted to Facebook and Livejournal.

In some example embodiments, the user supplies multiple sets of rules, with each set of rules comprising a profile. Profiles can be retrieved via the social hub's external application programming interfaces (APIs) and be provided within third party applications. The user may select a default profile to be applied by default to future posts, may select a profile to apply with each post, or both.

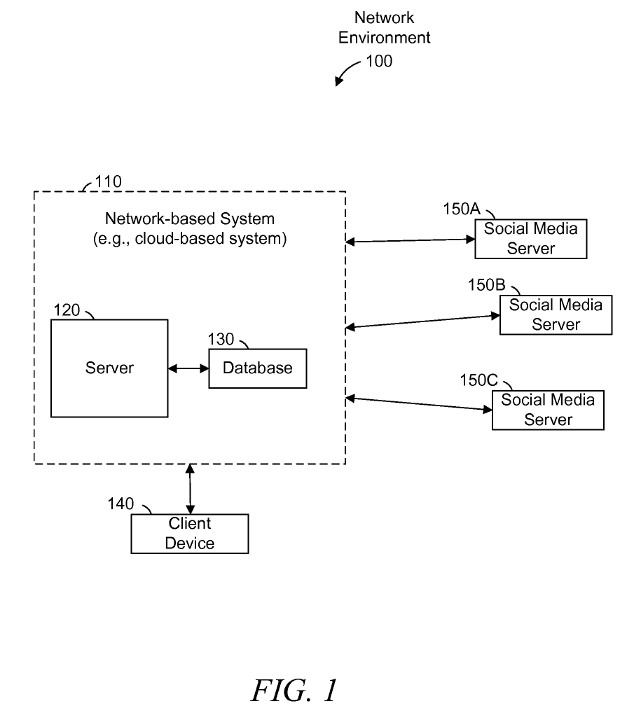

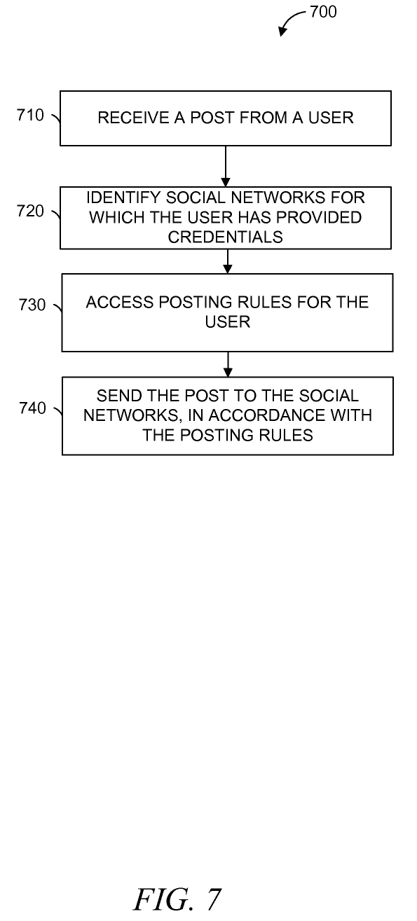

FIG. 1 is a network diagram illustrating a network environment 100 suitable for a social hub, according to some example embodiments. The network environment 100 includes a server machine 120, a database 130, a client device 140, and three social media servers 150A-150C, all communicatively coupled to each other via a network. The social media server 150A, associated with a first social media service, the social media server 150B, associated with a second social media service, and the social media server 150C, associated with a third social media service, may be referred to collectively as social media servers 150. The server machine 120 and the database 130 may collectively comprise a network-based system 110 (e.g., a cloud-based system) capable of acting as a social media hub for the social media servers 150. The client device 140 may originate social media postings to be transmitted to one or more of the social media servers 150 via the social media hub of the network-based system 110. The server machine 120 may host an application capable of dispatching tasks to the database 130. The server machine 120, the database 130, the client device 140, and the social media servers 150 may each be implemented in a computer system, in whole or in part, as described below with respect to FIG. 7.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, document-oriented NoSQL databases, a file storage, or any suitable combination thereof. The database may be an in-memory database. Moreover, any two or more of the machines, databases, or devices illustrated in FIG. 1 may be combined into a single machine, and the functions described herein for any single machine, database, or device may be subdivided among multiple machines, databases, or devices.

The network-based system 110, the client device 140, and the social media servers 150A-150C may be connected by one or more networks. Each network may be any network that enables communication between or among machines, databases, and devices. Accordingly, each network may be a wired network, a wireless network (e.g., a mobile or cellular network), or any suitable combination thereof. Each network may include one or more portions that constitute a private network, a public network (e.g., the Internet), or any suitable combination thereof.

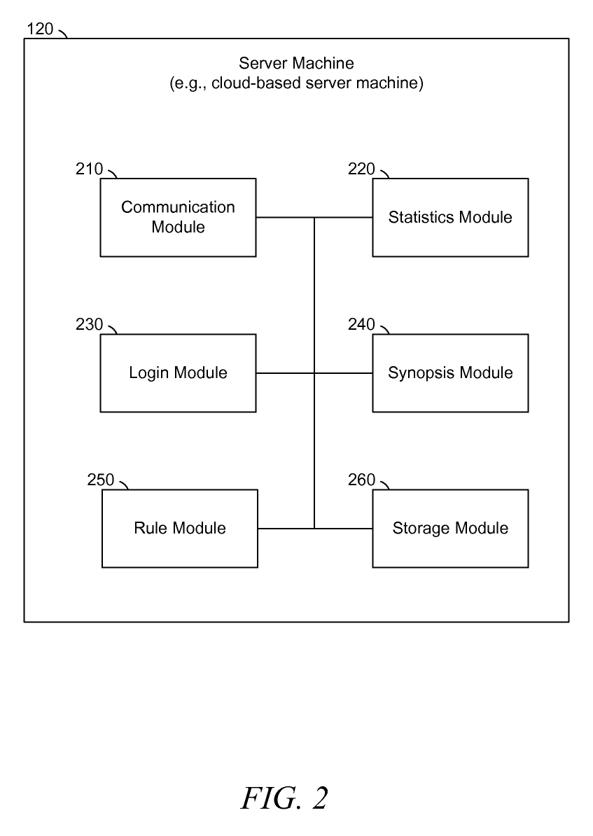

FIG. 2 is a block diagram illustrating components of the server machine 120, according to some example embodiments. The server machine 120 is shown as including a communication module 210, a statistics module 220, a login module 230, a synopsis module 240, a rules module 250, and a storage module 260, all configured to communicate with each other (e.g., via a bus, shared memory, or a switch). In some example embodiments one or more of the modules does not communicate with one or more other modules. For example, the rules module 250 may not communicate with the login module 230. Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the server machine 120 and transmits data from the server machine 120. For example, data may be received from the client device 140 for posting to the social media servers 150. Data containing rules to control the posting behavior may also be received from the client device 140. The communication module 210 may also transmit posts to the social media servers 150, transmit statistical data to the client device 140 or the social media servers 150, or any suitable combination thereof.

The statistics module 220 generates statistics regarding social media use. For example, statistics may be generated regarding the number of posts sent to each of the social media servers 150, the types of posts sent to each of the social media servers 150, the length of the posts sent to each of the media servers 150, demographic information regarding users posting to each of the media servers 150, or any suitable combination thereof. As used herein, the “type” of a post indicates the type of data contained within the post. For example, a post may include text, one or more images, one or more videos, one or more audio tracks, one or more links (e.g., links to web pages), or any suitable combination thereof. Accordingly, a post may have a type of text, image, video, audio, link, or any suitable combination thereof.

The login module 230 authenticates the server machine 120 on the social media servers 150. For example, the login module 230 may retrieve the user name and password, authentication tokens or any login relevant data for a particular social media server 150 from the database 130 using the storage module 260. The login module 230 can instruct the communication module 210 to transmit the retrieved user name and password to the social media server 150 for authentication.

The synopsis module 240 generates synopses for posts, when directed by the rule module 250. For example, a rule may specify that links to articles on the web be posted in full to the social media server 150A and only a synopsis be posted to the social media server 150B. In accordance with the rule, the synopsis module 240 may be directed to generate a synopsis from the web article. The synopsis may be generated by selecting a portion of the article such as the first paragraph, the first n sentences, the first image, or any suitable combination thereof.

The rule module 250 applies rules to posts received from the client device 140 to cause the appropriate data to be forwarded to the appropriate ones of the social media servers 150. For example, with respect to the example rule that specifies that links to articles on the web be posted in full to the social media server 150A and only a synopsis be posted to the social media server 150B, the rule module 250 may cause the communication module 210 to send a received web article in full to the social media server 150A and send a synopsis generated by the synopsis module 240 to the social media server 150B.

The storage module 260 stores the received rules, authentication data, statistics, and metadata about posts in the database 130. In some example embodiments, the storage module 260 also stores the posts, synopses, or both. In some example embodiments, posts and synopses are temporarily stored in the database 130, and then deleted. For example, a time-based rule may cause posts made between 9 am and 5 pm on weekdays to be delayed until 5:30 pm. Accordingly, posts made during the specified time may be stored in the database until the time for posting, posted at the indicated time, and then deleted from the database. This process may provide the desired delay with reduced impact to user privacy, compared to systems that archive posts indefinitely. In other example embodiments, refraining from storing the posts and synopses may serve to protect user privacy.

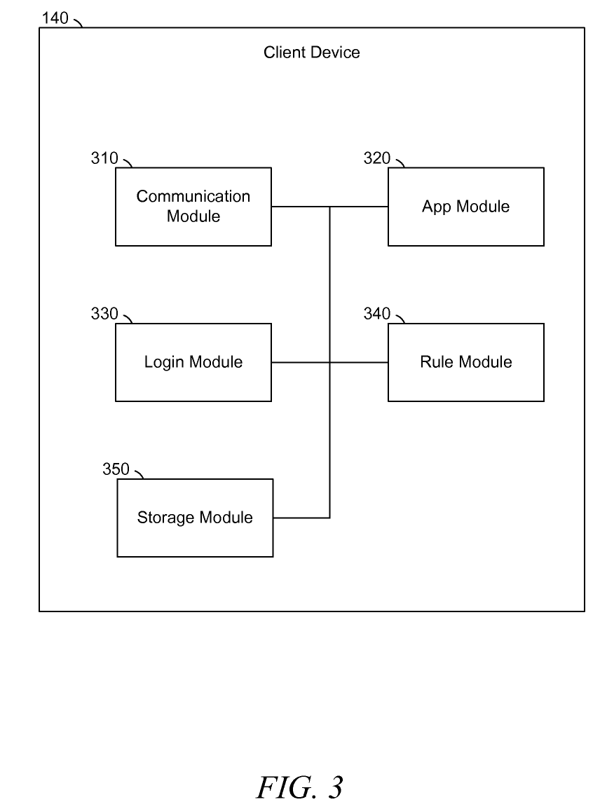

FIG. 3 is a block diagram of a client machine, according to some example embodiments, suitable for interacting with a social hub. The client device 140 is shown as including a communication module 310, an app module 320, a login module 330, a rule module 340, and a storage module 350, all configured to communicate with each other (e.g., via a bus, shared memory, or a switch).

The communication module 310 receives data sent to the client device 140 and transmits data from the client device 140. For example, data may be sent from the client device 140 for posting to the social media servers 150. The data may be sent directly to one or more of the social media servers 150 or sent to the server machine 120 for forwarding to appropriate ones of the social media servers 150. Data containing rules to control the posting behavior may also be sent from the client device 140 to the server machine 120 (e.g., via a web browser). The communication module 210 may also receive apps from an app store, communicate with app servers, or any suitable combination thereof.

The app module 320 provides one or more third-party applications to a user of the client device 140. For example, the client device 140 may be an iPad and the third-party application may be a game app. The game app may include an option to post results from the game to one or more social media services on which the player of the game has an account. Additionally or alternatively, the game app may include an option to post results to a social media hub implemented on the server machine 120.

The login module 330 provides user credentials to the server machine 120, the social media servers 150, or any suitable combination thereof. The user credentials may be stored in a memory of the client device 140 (e.g., using the storage module 350).

The rule module 340 provides one or more sets of rules to the server machine 120. For example, the rule module 340 may present a user interface on the client device 140. The user interacts with the user interface to provide rules, modify existing rules, delete existing rules, combine rules into a profile, select a default profile, or any suitable combination thereof. In some example embodiments, the user interface is a user interface of a web browser displaying data provided by the server machine 120. The rules gathered by the rule module 340 are communicated to the server machine 120 via the communication module 310. The storage module 350 stores data in a memory of the client device 140, retrieves data from the memory of the client device 140, or both.

According to various example embodiments, one or more of the methodologies described herein may facilitate posting information to a plurality of social media services via a social hub. Use of a social hub may reduce the number of posting actions taken by a user, the number of social networking APIs implemented by a third-party developer, or both. The use of rules within the social hub to control which posts are directed to which social media services may also reduce the level of effort expended by a user in determining where to send a particular post.

When these effects are considered in aggregate, one or more of the methodologies described herein may obviate a need for certain efforts or resources that otherwise would be involved in using social media services. Computing resources used by one or more machines, databases, or devices (e.g., within the network environment 100) may similarly be reduced. Examples of such computing resources include processor cycles, network traffic, memory usage, data storage capacity, power consumption, and cooling capacity.

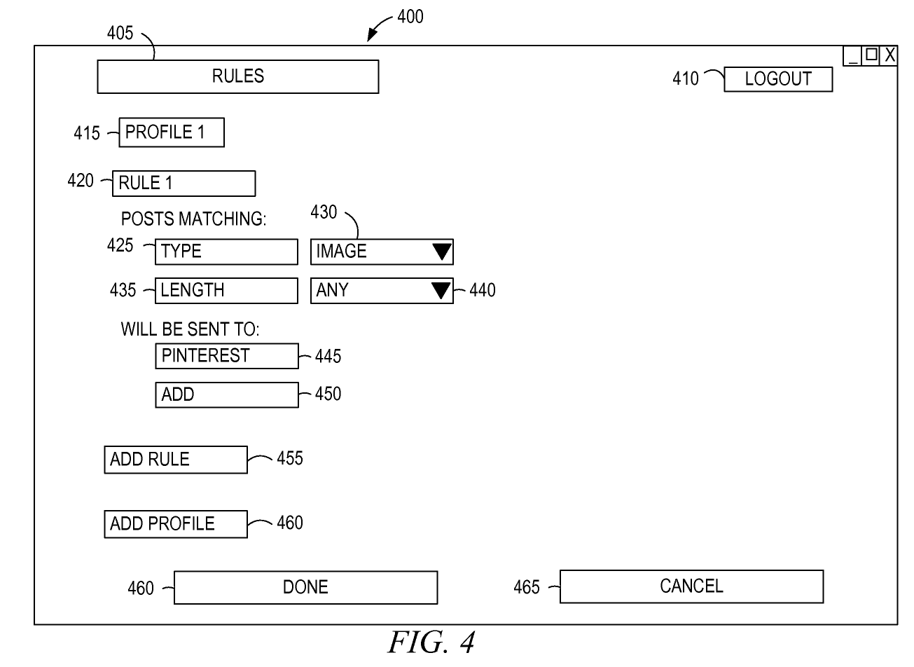

FIG. 4 is a block diagram illustrating a user interface 400 suitable for interacting with a configurable network communication processing system, according to some example embodiments. The example user interface 400 includes UI elements 405-465. In various example embodiments, the UI elements 405-465 may be implemented using UI components such as buttons, drop-down lists, text entry fields, text fields, radio buttons, check boxes, combo boxes, date pickers, or any suitable combination thereof.

The UI element 405 includes a label indicating that the UI 400 is a data entry screen for viewing, adding, and modifying forwarding rules for a user. The UI element 410 is operable to cause the user to log out of the rule modifying system. The UI 400 includes UI element 415, indicating that the information following it pertains to a first profile for the user. In the UI 400, only one profile is shown, but the UI element 460 is operable to add one or more additional profiles for the user. Similarly, the UI element 420 indicates that the following details pertain to a first rule of the first profile, and the UI element 455 is operable to add one or more additional rules to the first profile. Particular profiles may be associated with particular client devices. For example, a first profile may be associated with a personal device of a user and a second profile associated with a work device of the user. The user may configure the first profile to share posts on personal Facebook and twitter accounts, and the second profile to share posts on LinkedIn and a business Facebook account. Accordingly, when the server receives posts from the user from the personal device or the work device, rules from the corresponding profile are used to determine how the posts are handled.

The rule corresponding to the UI element 420 includes two parts. The first part, labeled “posts matching,” defines the set of posts to which the rule will be applied. The second part, labeled “will be sent to,” defines the set of social networks to which posts matching the criteria defined in the first part will be sent. In the example embodiment of FIG. 4, only two filters are applied. One filter is based on the type of the post, as indicated in UI element 425. The other filter is based on the length of the post, as indicated in UI element 435. The filters may be combined using a logical AND, a logical OR, by providing user commands to configure the nature of the combination, or any suitable combination thereof. For example, in an embodiment using logical AND, a single rule requiring an image and a length of at least 130 characters would only forward posts containing both an image and having text of at least defined length. In various example embodiments, more or fewer filters are used by default, the available filters may be customized, additional user-defined filters may be added, or any suitable combination thereof.

In some example embodiments, delay filters allow posts received at certain times of day to be delayed until a desired time for posting. For example, a rule may provide for all posts of type “link” to be sent to Facebook immediately if posted after 5 pm, before 9 am, or on weekends, but to be delayed until 5:30 pm if received between 9 am and 5 pm on weekdays.

In the example rule of the UI 400, posts having the image type (as indicated in the UI element 430) and any length (as indicated in the UI element 440) will be sent to Pinterest (as indicated in the UI element 445). The UI element 450 is operable to add additional social networks to the list of social networks for the rule. In some example embodiments, statistical data regarding rules by existing users are used to generate rule suggestions to the user. For example, if most users send image link posts to Pinterest and short text posts to Facebook and Twitter, two corresponding rules may be pre-generated and presented to new users for approval or modification.

The UI elements 460 and 465 may be implemented using buttons that are operable cause the acceptance and saving (UI element 460) or discard (UI element 465) of the changes made using the UI 400.

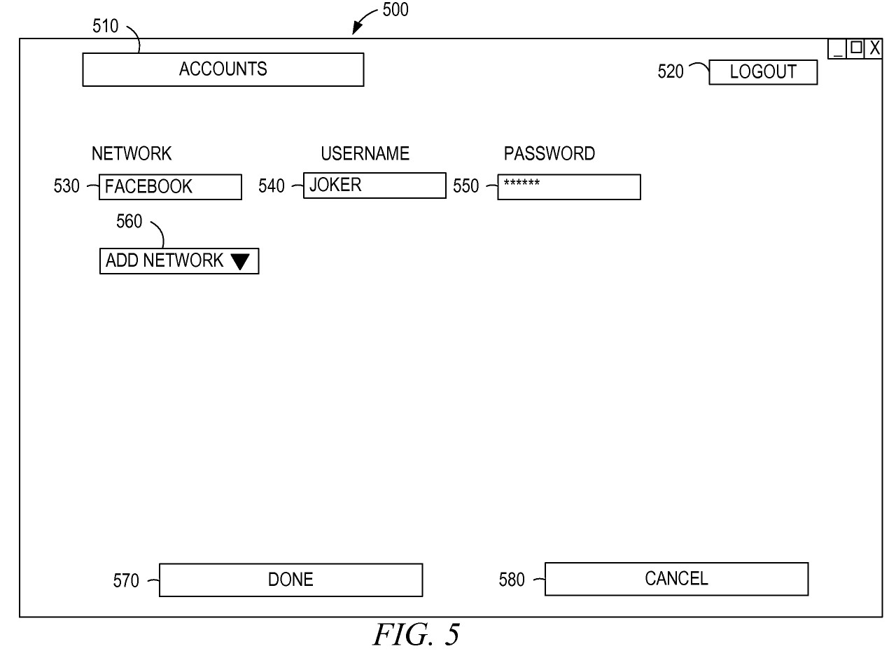

FIG. 5 is a block diagram illustrating a user interface suitable 500 for interacting with a configurable network communication processing system, according to some example embodiments. The example user interface 500 includes UI elements 510-580. In various example embodiments, the UI elements 510-580 may be implemented using UI components such as buttons, drop-down lists, text entry fields, text fields, radio buttons, check boxes, combo boxes, date pickers, or any suitable combination thereof.

The UI element 510 includes a label indicating that the UI 500 is a data entry screen for viewing, adding, and modifying account data for social networks for a user. The UI element 520 is operable to cause the user to log out of the account data modifying system. In the UI 500, only one social network account is shown, but the UI element 560 is operable to add one or more additional social network accounts for the user.

The UI element 530 indicates the name of the social network for which the user name in the UI element 540 and the password in the UI element 550 apply. The UI elements 570 and 580 may be implemented using buttons that are operable cause the acceptance and saving (UI element 570) or discard (UI element 580) of the changes made using the UI 500.

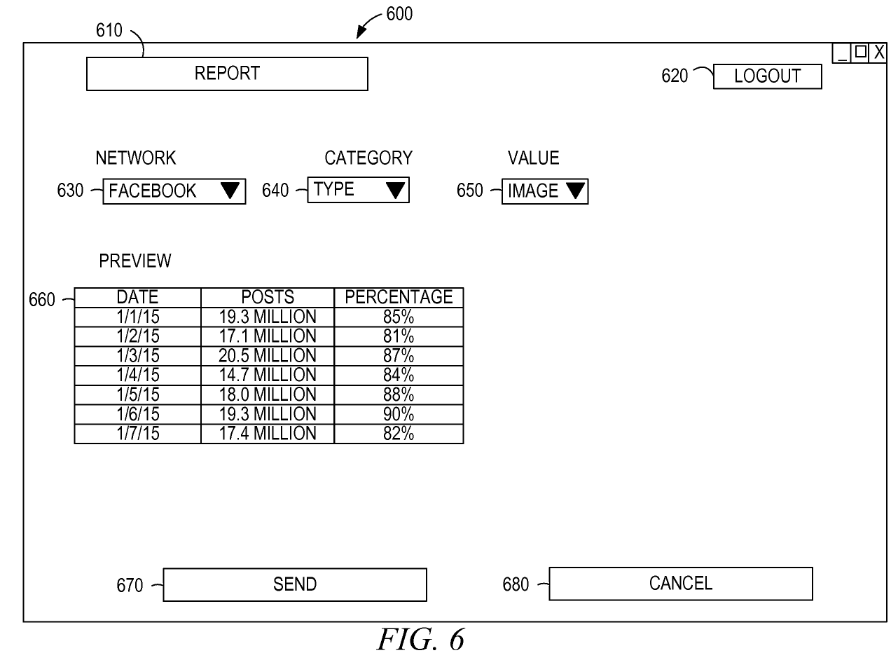

FIG. 6 is a block diagram illustrating a user interface 600 suitable for interacting with a configurable network communication processing system, according to some example embodiments. The example user interface 600 includes UI elements 610-680. In various example embodiments, the UI elements 610-680 may be implemented using UI components such as buttons, drop-down lists, text entry fields, text fields, radio buttons, check boxes, combo boxes, date pickers, or any suitable combination thereof.

The UI element 610 includes a label indicating that the UI 600 is a data entry screen for viewing, adding, and modifying reports for social networks from a social hub. The UI element 620 is operable to cause the administrator to log out of the report generation system.

The UI element 630 is shown as a drop-down menu operable to select the social network for which the report will be generated. In the example shown, the selected social network is Facebook. The UI element 640 is shown as a drop-down menu operable to select the category of filter to be applied in selecting posts for which statistics will be generated. In the example shown, the selected category is type. The UI element 650 is shown as a drop-down menu operable to select the value (or range) of the category of post for which the report will be generated. In the example shown, the selected type of post is image. Thus, a report will be generated to show the percentage of image posts that were sent to Facebook by the social hub. In some example embodiments, additional options are presented, such as a date range picker to select the range of dates for which the report will be generated, aggregation options, graph options for a visual presentation of results, or any suitable combination thereof.

The UI element 660 shows a portion of the generated report. As shown in the UI 600, the report shows a set of dates, along with a number of posts forwarded to the selected social network that comply with the selected criteria and a percentage. The percentage indicates the portion of the total number of posts complying with the selected criteria that were forwarded to the selected social network. For example, if, on Jan. 1, 2015, there were 22.7 million image posts made, and of those, 19.3 million were forwarded to Facebook, the report would indicate that 85% of image posts were made to Facebook on that date. It is noted that since a single post can be forwarded to multiple social networks, there is no requirement that the percentage of posts for a particular category add up to 100% across all social networks.

In the example report shown in FIG. 6, the percentage column shows the selected posts made to the selected network as a percentage of the selected posts made to all networks. In some example embodiments, the percentage column (or an additional percentage column) shows the selected posts made to the selected network in the selected time period as a percentage of the selected posts made to the selected network in a comparison time period. For example, the number of image posts to Facebook in January 2015 may be compared to the number of image posts to Facebook in January 2014 to show an annual change, to the number of image posts to Facebook in December 2014 to show a month-over-month change, or any suitable combination thereof. Another type of report that may be generated breaks the total number of posts into categories and identifies the percentage of posts falling in each category. For example, in a particular month, 20% of posts to Facebook may be image posts, 40% may be link posts, and 40% may be text posts. This report type may also be presented in a comparison format. For example, the percentage of image posts this month may be shown alongside the percentage of image posts last month. Alternatively or additionally, the percentage of posts of a particular type may be shown as a percentage of the percentage of posts of the same type in a previous time period. For example, if image posts are 20% of the total posts to Facebook this month, but image posts were 30% of the total posts to Facebook last month, the percentage of image posts this month is only 67% of the percentage of image posts last month. Accordingly, the 67% value may be displayed.

FIG. 7 is a flowchart illustrating operations, according to some example embodiments, of a social hub implementing a process 700 of distributing a post to social networks. As shown in FIG. 7, the process 700 includes operations 710, 720, 730, and 740. The process 700 is described as being performed by the server machine 120, using modules described above with respect to FIG. 2, by way of example and not limitation.

In operation 710, the communication module 210 receives a post from a user. For example, the user may submit the post from a user interface on the client device 140 dedicated to providing posts to the social hub. As another example, an app running on the client device 140 may generate a post on behalf of the user (e.g., in response to the user clicking a “share” button within the app).

The login module 230 identifies social networks for which the user has provided credentials (operation 720) and the rule module 250 accesses the posting rules (operation 730) that define how the received post is processed with respect to each of the identified social networks.

In operation 740, the post is sent to the identified social networks, in accordance with the rules for the user's account. The social networks may receive content pushed via a connector interface. The storage module 260 may store connector plugins that implement the connection to each social network. The connector plugins may be supplied by the operator of the social hub or by the social networks.

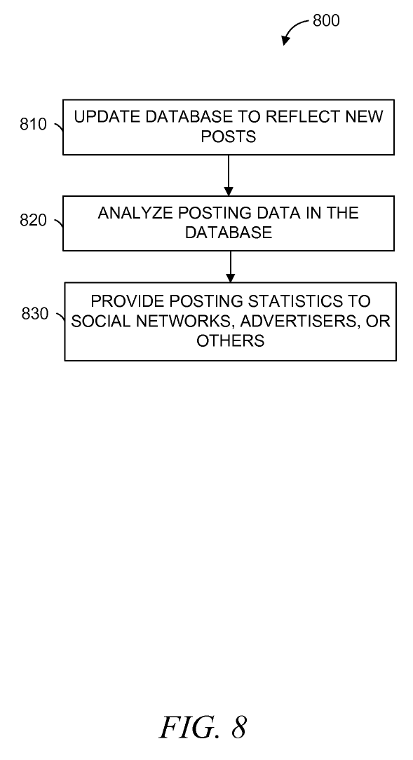

FIG. 8 is a flowchart illustrating operations, according to some example embodiments, of a social hub implementing a process 800 of analyzing posts to social networks. As shown in FIG. 8, the process 800 includes operations 810, 820, and 830. The process 800 is described as being performed by the server machine 120, using modules described above with respect to FIG. 2, by way of example and not limitation.

In operation 810, the database 130 is updated to reflect new posts. For example, operation 810 may be performed each time the process 700 is performed, to keep the database 130 up to date with respect to posting activity. The data stored in operation 810 may be metadata regarding the posts rather than the actual posted data. For example, the type of data sent to each social network, the amount of data sent, the time at which data was sent, or any suitable combination thereof may be stored.

The statistics module 220 analyzes the posting data in the database, in operation 820. For example, one or more of the following may be determined: the aggregate number of posts to each social network over a period of time, the number of posts to each social network of each type, the number of posts to each social network within various size ranges, and the number of posts to each social network originating from users within particular demographic groups. The operation 820 may be performed periodically (e.g., on a daily basis), in response to a specific request (e.g., a request from a social network for a report), or both.

In operation 830, the statistics module 220 provides statistics. For example, statistics regarding a particular social network may be provided to that network, to competing networks, to advertisers, to news outlets, to administrators of the social hub, or any suitable combination thereof. The statistics may be provided in exchange for a set fee, in exchange for access to information provided by the counter-party, or both. In some example embodiments, user-level controls are provided to allow users to determine who may access metadata derived from their posts. Similarly, some example embodiments allow social networks to determine who may access metadata derive from posts directed to their social network.

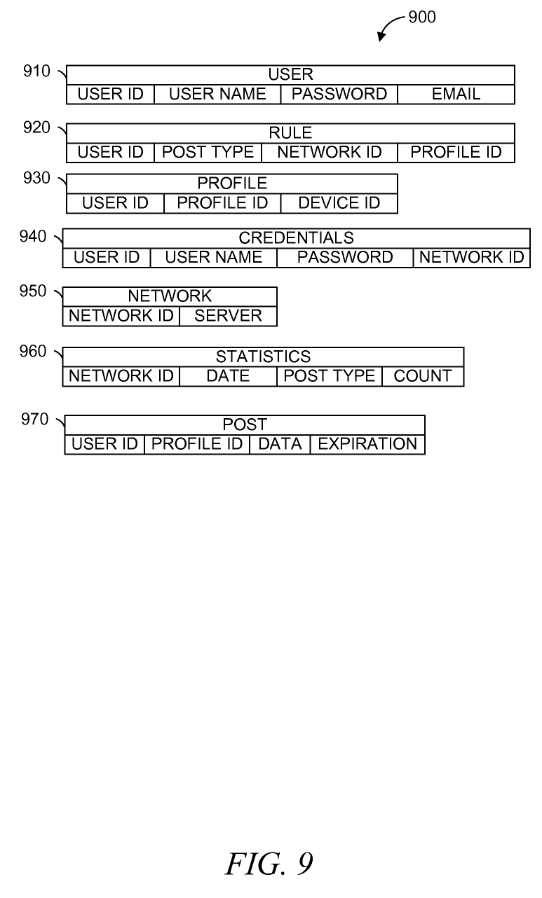

FIG. 9 is a database schema 900, according to some example embodiments, for use in a social hub. The database schema 900 includes a user table 910, a rule table 920, a profile table 930, a credentials table 940, a social network table 950, a statistics table 960, and a post table 970.

The user table 910 contains information for each user of the social hub. For example, a unique identifier for the user, a name of the user, a password for the user, and an email address for the user may be stored in the user table 910. The identifier for the user may be used to cross-reference data in other tables. The user name and password may be used to authenticate the user on the social hub. The email address of the user may be used to contact the user (e.g., in case of a forgotten password).

The rule table 920 contains rules used by the rule module 250 to determine how posts are directed to social networks. In the example rule table 920, each row contains a user identifier (ID) that indicates the user to which the rule applies, a post type that indicates the types of posts to which the rule applies, a network identifier that indicates which network posts of the post type should be sent, and a profile identifier to which the rule belongs. For example, a particular rule may indicate that posts of type “image” for user ID “1” should be forwarded to Facebook (as indicated by a corresponding network identifier). Using this schema, a user would have one row in the rule table 920 for each social network to receive each type of post. For example, if the user wanted to forward “image” posts to three different social networks, three rows in the rule table 920 would be used. Rules belonging to the same profile of a user have the same value in the profile ID column (as well as the same value in the user ID column).

The profile table 930 associates particular profiles with particular devices that may be used by a user. In the example profile table 930, each row contains a user ID that indicates the user to which the row applies, the profile ID itself, and a device identifier. When a post is received, a device ID may be determined (e.g., by recognizing the IP address of the device or by reading a value from a cookie stored on the device) and compared with the values in the profile table 930 associated with the user. If a match is found, the rules in the rule table 920 having values in the profile ID column that matches the profile ID corresponding to the device ID are used. If no match is found, the default profile for the user is used. In some example embodiments, a particular profile ID value (e.g., 1 or 0) indicates the default profile. Alternatively, an additional column may be present in the profile table 930, used to indicate which profile is the default profile for the user.

The credentials table 940 contains user credentials used by the login module 230 to connect to the various social networks. In the example credentials table 940, each row contains a user identifier that indicates the user to whom the credentials belong, a user name and password used to identify and authenticate the user, and a network identifier that identifies the social network to which the credentials apply. In some example embodiments, additional or alternate credential tables are used, to store other types of authentication data. For example, instead of storing the user's password, a token signed using a private key of the user may be stored. By receiving the signed token and decrypting it with the user's public key, the receiving social network can confirm that the token was signed by the user. The token may contain a message indicating that the social hub is authorized to post messages on the user's behalf. Other authentication systems such as OAuth and Kerberos may also be used. For example, the server 120 may establish a trust relationship with the service using an API provided by the service. The trust relationship may last for a predefined period of time. Upon expiration of the time period, the trust relationship may be renewed using the user-provided authentication information.

The network table 950 contains information regarding each social network. For example, the network table 950 may contain a unique identifier for each social network along with connection information such as a server name for the social network. In some example embodiments, additional information for each social network is stored. For example, a display name of the social network, an icon representing the social network, a preferred type of data associated with the social network, or any suitable combination thereof.

The statistics table 960 contains metadata regarding the posts forwarded by the social hub. As shown in the schema 900, the statistics table 960 includes columns for the network identifier to which posts were forwarded, the date on which posts were forwarded, the type of posts that were forwarded, and the count of posts that were forwarded. For example, a populated row of the statistics table 960 could indicate that Facebook received 200 text posts on Mar. 6, 2015. The statistics table 960 may be updated after each post is made. In some example embodiments, additional or alternative fields are used in the statistics table 960. For example, to support statistics based on the length of each post, a length field (e.g., a field storing a length range such as 1-140 characters, 141-500 characters, 500-1000 characters, and 1001+ characters) may be added to the statistics table 960. As another example, to support statistics based on user demographics, one or more demographic fields (e.g., age, gender, income) may be added to the user table 910 and the statistics table 960. Accordingly, when the statistics table is updated to account for a post being made to a social network, the row corresponding to the demographic data for the posting user and the length of the post is used.

The post table 970 provides storage for posts provided by users. As shown in the schema 900, the post table 970 includes columns for the user that generated the post, the profile of the user in effect when the post was generated, the data of the post, and an expiration date of the post. In some example embodiments, the posts are discarded when the expiration date is reached, the post is processed according to the rules of the profile corresponding to the profile ID, or both. For example, consider a user having a personal smart phone and a work computer. The user creates two profiles, and associates one with each device. The user further creates rules such that when posts are made from the personal smart phone during business hours, those posts are delayed until 6:00 pm. Accordingly, when the user makes a post from the personal smart phone during business hours, an entry in the post table 970 is created. The entry indicates the user, the profile associated with the smart phone, the data of the post, and 6:00 pm. The configurable network communication processing system periodically queries the post table 970 to find recently-expired entries, applies the rules associated with the indicated user and profile identifiers, and forwards the post to the indicated services according to the rules. In some example embodiments, the post entry is deleted after processing. Alternatively, an additional column may be added to the post table 970 to indicate that the post entry has already been processed.

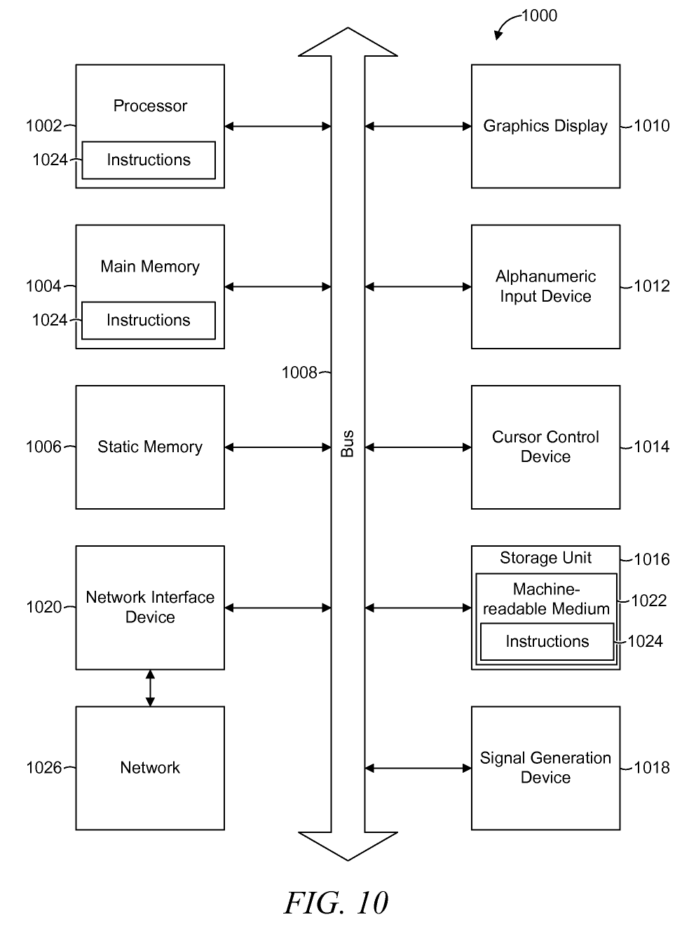

FIG. 10 is a block diagram illustrating components of a machine 1000, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 10 shows a diagrammatic representation of the machine 1000 in the example form of a computer system and within which instructions 1024 (e.g., software, a program, an application, an applet, an app, or other executable code) for causing the machine 1000 to perform any one or more of the methodologies discussed herein may be executed, in whole or in part. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include a collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a light emitting diode (LED) display, a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1000), such that the instructions, when executed by one or more processors of the machine (e.g., processor 1002), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an application-specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a post from a client device, the post being associated with a user account, the user account being associated with a plurality of social networks, each social network of the plurality of social networks having a corresponding server of a plurality of servers;
accessing, from a database, a set of rules for the user account;
based on the set of rules for the user account, identifying a social network of the set of social networks to receive the post;
accessing, from the database, credentials for the social network based on the user account;
establishing a connection, by a processor of a machine, to the server using the accessed credentials; and
forwarding, through the established connection, the post to the server corresponding to the identified social network.

2. The method of claim 1, wherein:
the post includes an image;
an image rule of the set of rules is directed to a disposition of posts including images; and
the forwarding of the post to the social network is in accordance with the image rule.

3. The method of claim 1, wherein:
the post includes a link;
a link rule of the set of rules is directed to a disposition of posts including links; and
the forwarding of the post to the social network is in accordance with the link rule.

4. The method of claim 1, wherein:
the post includes text having a length;
a length rule of the set of rules is directed to a disposition of posts including text exceeding a predetermined length;
the method further comprises comparing the length of the text to the predetermined length of the length rule; and
the forwarding of the post to the social network is in accordance with the length rule.

5. The method of claim 1, further comprising:
receiving user credentials for the one or more social networks;
storing the user credentials; and
wherein the forwarding of the post to the social network includes accessing the stored user credentials.

6. The method of claim 1, further comprising:
generating a synopsis of the post; and
forwarding the synopsis to a second social network of the set of social networks, in accordance with the set of rules.

7. The method of claim 6, wherein:
the synopsis is a text synopsis;
the post comprises an image; and
wherein the generating of the synopsis includes generating a text description of the image.

8. The method of claim 1, further comprising:
storing metadata regarding the post and the social network to a database, the database including metadata regarding a plurality of additional posts associated with additional user accounts;
analyzing the stored metadata to generate statistics regarding social media use; and
causing the generated statistics to be presented on a display device.

9. A system comprising:
a database storing:
associations between a user account on a social hub and a set of social networks;
a set of network addresses corresponding to the set of social networks;
a set of rules for the user account; and
user credentials for accounts on each social network of the set of social networks
a communication module configured to:
receive a post from a client device, the post being associated with the user account on the social hub; and
a rule module configured to:
access the set of rules for the user account; and
identify a social network of the set of social networks, in accordance with applying the set of rules to the post
the communication module being further configured to:
forward the post to the network address corresponding to the identified social network.

10. The system of claim 9, wherein:
the post includes an image;
an image rule of the set of rules is directed to a disposition of posts including images; and
the forwarding of the post to the social network is in accordance with the image rule.

11. The system of claim 9, wherein:
the post includes a link;
a link rule of the set of rules is directed to a disposition of posts including links; and
the forwarding of the post to the social network is in accordance with the link rule.

12. The system of claim 9, wherein:
the post includes text having a length;
a length rule of the set of rules is directed to a disposition of posts including text exceeding a predetermined length;
the rule module is further configured to:
compare the length of the text to the predetermined length of the length rule; and
the forwarding of the post to the social network is in accordance with the length rule.

13. The system of claim 9, wherein:
the communication module is further configured to:
receive the user credentials for the one or more social networks;
the system further comprises a storage module configured to:
store the user credentials in the database; and
the forwarding of the post to the network address includes accessing the stored user credentials.

14. The system of claim 9, further comprising:
a synopsis module configured to:
generate a synopsis of the post; and
wherein the rule module is further configured to:
forward the synopsis to a second network address corresponding to a social network of the set of social networks, in accordance with the set of rules.

15. The system of claim 14, wherein:
the synopsis is a text synopsis;
the post comprises an image; and
wherein the generating of the synopsis includes generating a text description of the image.

16. The system of claim 9, further comprising:
a statistics module configured to:
store metadata regarding the post and the social network to a database, the database including metadata regarding a plurality of additional posts associated with additional user accounts;
analyze the stored metadata to generate statistics regarding social media use; and wherein
the communication module is further configured to:
cause the generated statistics to be presented on a display device.

17. A non-transitory machine-readable storage medium comprising instructions that, when executed by one or more processors of a machine, cause the machine to perform operations comprising:
receiving a post from a client device, the post being associated with a user account, the user account being associated with a plurality of social networks, each social network of the plurality of social networks having a corresponding server of a plurality of servers;
accessing, from a database, a set of rules for the user account;
based on the set of rules for the user account, identifying a social network of the set of social networks to receive the post;
accessing, from the database, credentials for the social network based on the user account;
establishing a connection, by a processor of a machine, to the server using the accessed credentials; and
forwarding, through the established connection, the post to the server corresponding to the identified social network.

18. The non-transitory machine-readable storage medium of claim 17, wherein:
the post includes an image;
an image rule of the set of rules is directed to a disposition of posts including images; and
the forwarding of the post to the social network is in accordance with the image rule.

19. The non-transitory machine-readable storage medium of claim 17, wherein:
the post includes a link;
a link rule of the set of rules is directed to a disposition of posts including links; and
the forwarding of the post to the social network is in accordance with the link rule.

20. The non-transitory machine-readable storage medium of claim 17, wherein:
the post includes text having a length;
a length rule of the set of rules is directed to a disposition of posts including text exceeding a predetermined length;
the method further comprises comparing the length of the text to the predetermined length of the length rule; and
the forwarding of the post to the social network is in accordance with the length rule.
